(19) United States
(12) Patent Application Publication
(10) Pub. No.: US 2012/0174156 A1
(43) Pub. Date: Jul. 5, 2012

(54) SYSTEM AND METHOD FOR PRESENTING INFORMATION ASSOCIATED WITH A CONTACT FOR VIDEO CALLING

(75) Inventors: Joon Young Park, Burbank, CA (US); Allyson J. Beuhler, Woodridge, IL (US); Michael S. Thiems, Edwardsville, IL (US)

(73) Assignee: GENERAL INSTRUMENT CORPORATION, Horsham, PA (US)

(21) Appl. No.: 12/982,934

(22) Filed: Dec. 31, 2010

(51) Int. Cl. H04N 5/445; H04N 7/173

(52) U.S. Cl. 725/40; 725/106

(57) ABSTRACT

A method for presenting information associated with a contact for video calling is disclosed. The method comprises storing a list of favorite contacts of a user. In an electronic program guide (EPG) user interface, a plurality of contact identifiers corresponding to the list of favorite contacts is displayed together with program information. An input from the user is received to highlight a selected one of the contact identifiers. In the EPG user interface, a status video associated with a contact associated with the selected one of the contact identifiers is displayed.

### BACKGROUND

Conventional digital set-top boxes (STBs) often enhance a television viewer's experience by employing one or more electronic program guides (EPGs). As known in the art, the electronic program guide lists scheduled programs for a predetermined period of time (e.g., two weeks) and provides, among others, information about broadcast dates and times and content information. For example, the program attributes may include the content information, which can describe for each program the channel, actor, director, title, genre, language and the like. With an EPG, television viewers navigate through an onscreen program guide to locate programming. Typically viewers browse the guide or query it. With a guide, viewers browse currently available programming and schedules of programming available in the future. By using keywords or categories, viewers typically search the guide for programming. With an EPG, the viewers may also set reminders for upcoming programs or enter instructions to record one or more shows.

Recent advent of voice-over-internet-protocol (VoIP) telephony services, internet-protocol television (IPTV) services, and the push for convergence of digital technologies also have given rise to new STBs that are capable of providing consumers with both video programming and telephone services. For example, some existing STBs can provide users with both telephony and television services and the ability to display caller identification during television viewing.

Session Initiation Protocol (SIP) is a standardized protocol that allows establishment of one-to-one communication between devices. SIP is an application-layer control protocol. SIP is commonly used as a signaling protocol for internet telephony or VoIP (Voice-Over-Internet Protocol). SIP can establish sessions for features such as audio/videoconferencing, interactive gaming, and call forwarding to be deployed over IP (Internet Protocol) networks, thus enabling service providers to integrate basic IP telephony services with Web, e-mail, and chat services. In addition to user authentication, redirect and registration services, SIP supports traditional telephony features. SIP also supports publish, subscribe, and notify functionality for event state publication.

### SUMMARY

In one embodiment of the present invention, a method is provided for presenting information associated with a contact for video calling. The method comprises storing a list of favorite contacts of a user. In an electronic program guide (EPG) user interface, a plurality of contact identifiers corresponding to the list of favorite contacts is displayed together with program information. An input from the user is received to highlight a selected one of the contact identifiers. In the EPG user interface, a status video associated with a contact associated with the selected one of the contact identifiers is displayed.

In another embodiment of the present invention, a further method is provided for presenting information associated with a contact for video calling. In a consumer portal server, a status video associated with a user and a list of favorite contacts for video calling associated with the user are stored. The status video is sent to one or more contacts selected from the list of favorite contacts for video calling.

In a further embodiment of the present invention, a system is provided for presenting information associated with a contact for video calling. The system includes a set-top box (STB) configured to output video to a display. The STB is communicatively coupled to an access network for accessing a consumer portal server and a call control server. The STB includes a processor configured to execute an electronic program guide (EPG) application. A user interface of the EPG application is configured to display, together on the display, program schedule information, and a plurality of contact identifiers corresponding to a list of favorite contacts for video calling associated with a user of the set-top box, and a status video associated with a selected contact of the list of favorite contacts.

### BRIEF DESCRIPTION OF THE DRAWINGS

FIG. 1 is a block diagram that illustrates an exemplary system according to an embodiment of the present invention.

FIG. 2 is an exemplary electronic program guide screen in accordance with an embodiment of the present invention.

FIG. 3 is a flow diagram that illustrates a method according to an embodiment of the present invention.

FIG. 4 is a flow diagram that illustrates a method according to a further embodiment of the present invention.

### DETAILED DESCRIPTION

Aspects of the present invention provide a user of a video calling system with a convenient way to initiate a video call or conference with contacts to whom the caller frequently talks. In an embodiment, availability of those people can displayed, like channel listings, at the electronic program guide of a set-top box. As the user moves a cursor over the identifier associated with a contact (e.g., a potential callee), a status video recorded by the contact can be displayed; for example, at the bottom of the program guide. Each user of the video calling system can optionally update their status video as often as desired. The status video provides a way for each user to communicate a status to potential callers on the video calling system.

Before describing in detail embodiments that are in accordance with the present invention, it should be observed that the embodiments reside primarily in combinations of method steps and apparatus components related to a system and method for presenting information related to a contact for video calling. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

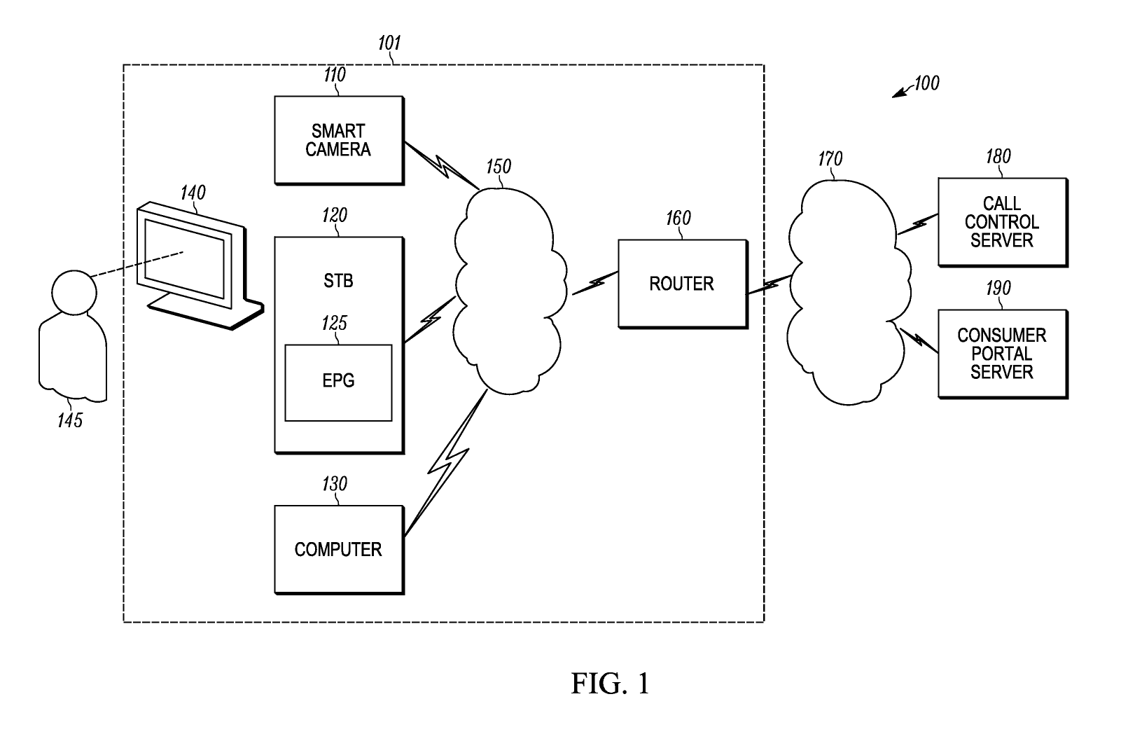

FIG. 1 illustrates an exemplary system 100 in accordance with an embodiment of the present invention. However, it will be understood by a person having ordinary skill in the art that aspects of the invention can be practiced using a system having other than the specific features or limitations of the illustrative system 100 described herein.

The depicted system 100 includes a client system 101 connected through an access network 170 (e.g., the Internet or a broadband access network) to a call control server 180 and to a consumer portal server 190. The client system 101 includes a router 160 (which may include, for example, a gateway, residential gateway, cable modem, and the like) that connects to access network 170 and that creates a local area network, e.g., home network 150. A set-top box (STB) 120, a smart camera device 110, and an optional computer 130 each connect to the home network 150, e.g., by a wireless or wired connection. The set-top box 120 is connected to a display 140. Examples of display 140 include a television or a monitor.

A client system 101 typically is located in end-user (subscriber) locations, such as a home or office of a user 145. In some cases, a home or other end-user location has only one set-top box 120 and/or smart camera device 110, although in many cases, more than one of each can be located in the same end-user location, e.g., as part of a home network or business network configuration.

It will be understood by a person having ordinary skill in the art that the terminology “set-top” does not in any way limit the physical placement of the set-top box 120; that is, the set-top box 120 need not be positioned on top of a television set. Each set-top box 120 is any suitable signal processing device or system for processing video signals, such as any signal converter or decoder (set-top) box, or other suitable computing device or video device with set-top box and/or cable modem capabilities, including a residential gateway; an internet protocol (IP), satellite, or cable digital video recorder; a digital video disk (DVD) recorder; a computer; or a home media server system. In further embodiments, set-top box 120 can be a laptop, notebook, or tablet computer, or a mobile device, or can be built into the display 140 (e.g., a networked smart TV). An exemplary set-top box 120 comprises a computing device that connects the display 140 and an external signal source, turning the signal into a content stream that the display 140 is able to render and display. For example, set-top box 120 can convert data signals to audio/video content and output the data to display 140. Set-top box 120 is communicatively coupled to the display 140 via a wired or wireless connection.

A set-top box 120 can be completely or partially configured in the form of hardware circuitry and/or other hardware components within a larger device or group of components. Alternatively, set-top box 120 can be completely or partially configured in the form of software, e.g., as processing instructions or one or more sets of logic or computer code. In such configuration, the logic or processing instructions typically are stored in a data storage device, which typically is coupled to a processor or controller. Both the data storage device and the processor or controller can be included as part of a set-top box 120, although such is not necessary. The processor or controller accesses the necessary instructions from the data storage device and executes the instructions or transfers the instructions to the appropriate location within the set-top box 120.

The set-top box 120 is able to provide the user 145, via display 140, with a user interface of an electronic program guide (EPG) 125. In an embodiment, the user interface of program guide 125 shows not only conventional channel listings, but also a list of favorite contacts with whom the user 145 frequently communicates.

Some embodiments can include a computer 130. For example, the user 145 may use the computer 130 to access and maintain a calendar. The calendar can be a calendar stored within the computer 130 (e.g., an Outlook calendar, Windows Vista calendar, etc.), or may be stored “in the cloud,” such as on one or more servers outside of client system 101 (e.g., Google Calendar, Yahoo Calendar, etc.). In another embodiment, the user 145 has a calendar stored on a server (e.g., consumer portal server 190) of a provider of the program guide. In a further embodiment, the user 145 is able to publish the calendar to those contacts who have added the user 145 into their own list of favorite contacts. In some embodiments, the aforementioned functionality of computer 130 can be combined with or included in the smart camera device 110, the STB 120, or the router 160.

The smart camera device 110 is connected to the home network 150 and communicatively coupled to the set-top box 120 through home network 150, either via a wired or wireless connection. In a further embodiment, smart camera device 110 can include a Session Initiation Protocol (SIP) client.

In some embodiments, smart camera device 110 can be a dedicated device. In further embodiments, smart camera device 110 can be built into the set-top box 120. In such embodiments, the smart camera device 110 is controllable via the user interface of the program guide 125 within the STB 120.

In still further embodiments, the smart camera device 110 can be a portable or mobile device having an integral or attached video camera. For example, smart camera device 110 can be included in a computer (e.g., a laptop, notebook, or tablet computer), or a mobile device or smartphone, and/or can be completely or partially configured in the form of software running on a processor. Illustrative examples of such embodiments include, for example, a smartphone with a front-facing camera, a tablet with a front-facing camera, or a laptop computer with an integrated webcam. In such embodiments, the smart camera device 110 can act, for example, as a companion device to the STB 120, e.g., by running user interface software in the smart camera device 110 to present a companion EPG (not shown) on a display screen of the portable or mobile device. In such embodiments, the inventive features of electronic program guide 125 that are disclosed herein can be included instead in the companion EPG of the portable or mobile device, and the user interface of the companion EPG would accordingly be displayed on the display screen of the portable or mobile device rather than on display 160.

The smart camera device 110 can be used to capture local video, e.g., while a remote video is shown on the display 160. A window showing video captured by smart camera device 110 (e.g., a self-view window showing the user 145) may be shown on display 160 and/or on a display screen of smart camera device 110.

Under the control of program guide 125, the smart camera device 110 can initiate or receive a video call with a second smart camera (not shown) associated with a user of another client system (not shown) that is connected to access network 170. In an exemplary embodiment, a video call is established between first and second smart camera devices across access network 170 by one or more call control servers 180, allowing the two smart camera devices to send and receive media streams (e.g., video and audio) to and from each other.

Call control server 180 uses a protocol, such as SIP, for controlling multimedia communication sessions such as voice and video calls over Internet Protocol (IP). Call control server 180 comprises, in an embodiment, a SIP registrar, and multiple SIP proxies and SIP redirect servers. In further embodiments, Hypertext Transfer Protocol (HTTP)-based protocols (e.g., Ajax and/or Comet) may be used instead of or in addition to SIP. Call control server 180 is able to, for example, establish video calls between or among a plurality of smart camera devices such as smart camera device 110. In a further embodiment, call control server 180 can establish a call between a smart camera device 110 and a user of one or more third party video calling services (e.g., Skype, Google video chat, Yahoo Messenger, and the like).

The consumer portal server 190 can store private data of user 145, including, for example, contacts, contact groups, favorite lists of contacts, blacklists of contacts, calendar, personalized program guides, and so on. A favorite list, for example, can be configured to automatically include a selected number of contacts (e.g., a top three, top five, or top ten list) with whom the user 145 frequently talks. In other embodiments, a favorite list can include or can consist of a number of favorite contacts personally selected by the user 145. In an exemplary embodiment, when the user 145 launches the program guide application 125 within the STB 120, the program guide application 125 is able to retrieve the favorite list from consumer portal server 190, and can display the favorite list of contacts on display 140. For example, program guide application 125 can display favorite contacts together with (e.g., above, below, or alongside) program guide menus and/or displays not otherwise related to video calls (e.g., channel selection, program schedules, video content navigation).

In some embodiments, the consumer portal server 190 may comprise a third-party Internet portal (e.g., Google, Yahoo, MSN, Facebook) where the user 145 is able to store and maintain personal contact and/or calendar information. In other embodiments, the consumer portal server 190 may be provided by the program guide provider, and may be configurable (e.g., by the user 145) to synchronize data periodically with one or more third-party Internet portals. In still further embodiments, the functionality of the consumer portal server 190 can be included in call control server 180.

An exemplary consumer portal server 190 can be accessed using standards and/or protocols such as SIP, HTTP, Really Simple Syndication (RSS), Atom, Comet, and the like, so that with proper authentication, any Internet applications (including, for example, an Internet browser running on computer 130 or elsewhere), can access private data of user 145 to the extent that user 145 grants permission for such access.

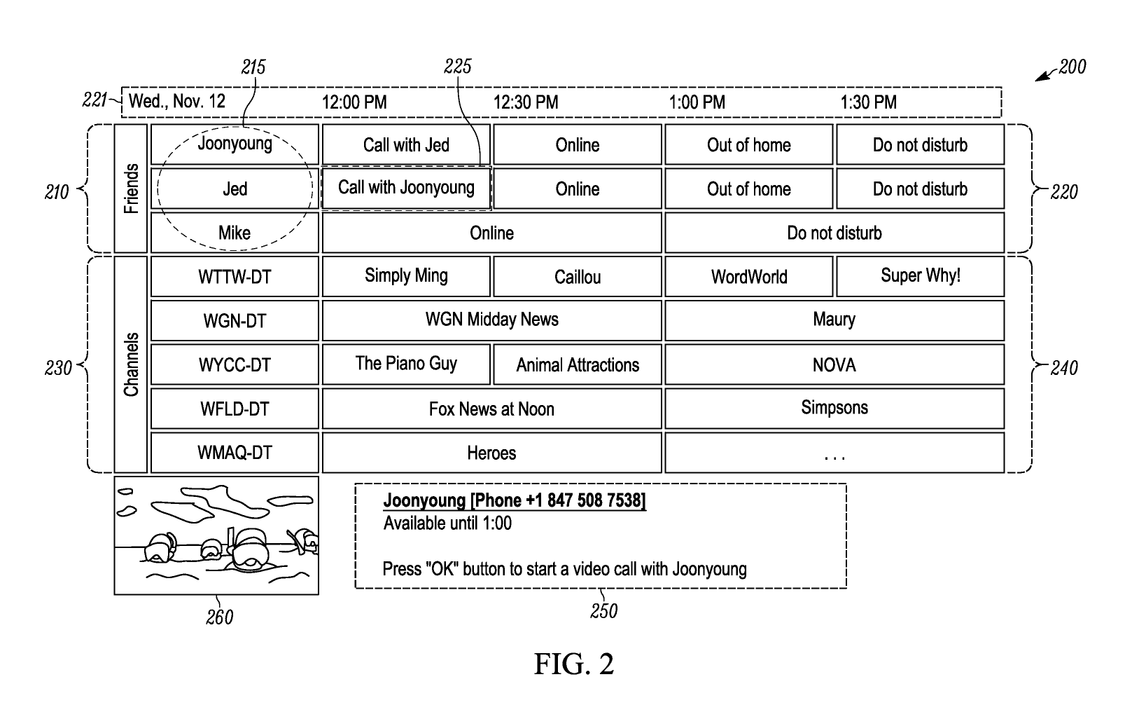

FIG. 2 illustrates an exemplary EPG screen 200 in accordance with an embodiment of the present invention. It will be understood that the screen layouts and elements, including captions, channels, names, titles, calendar dates/times/events, and content items, that are depicted in FIG. 2 are illustrative and non-limiting examples. For example, while FIG. 2 depicts a grid of items in a text format (such as television content items described by program name), may include other or additional information, such as episode titles, summaries, ratings, logos, images, screenshots or thumbnails of one or more selected video frames, animated or moving pictures, hyperlinks to further information, and the like. Further examples of EPG screen 200 may be in the form of a grid, table, or other kind of layout, may include scrolling or paging features, and so forth. Numerous variations of EPG screen 200 will be apparent to a person having skill in the art, without departing from the scope and spirit of the present invention.

The exemplary timeline 221 shows a date and a range of times. In the depicted example, a two hour span from 12:00 PM to 2:00 PM on Wednesday, November 12 is shown on timeline 221. The times shown on timeline 221 serve as a header row for the grid beneath timeline 221.

Program schedule information is displayed. The program schedule information includes channel listing 230 and schedule grid 240, along with timeline 221, which are conventional features of an electronic program guide. Each line of channel listing 230 shows, for example, an identifying name for a channel of programming (e.g., call letters of broadcast channels, names of non-broadcast channels).

Each line of schedule grid 240 corresponds to a line of channel listing 230, and shows, for example, programs that can be selected for viewing by the user 145 on the corresponding channel, during the corresponding time period of timeline 221.

Each line of contact listing 210 shows an identifying name for a contact from the favorite list of contacts 215. In some embodiments, the entire favorite list of contacts 215 can be displayed in contact listing 210 without scrolling. In other embodiments, contact listing 210 shows only a portion of a larger favorite list of contacts 215 (e.g., the top three from a list of ten), which may in some embodiments be scrollable or pageable to show additional selections from the favorite list of contacts 215.

Each line of calendar grid 220 corresponds to a line of contact listing 210, and shows events or presence indicators (e.g., “free,” “unknown,” “out of home,” “out of office,” “do not disturb,” “online,” “offline,” “busy,” “in a meeting”, and the like). In an embodiment, the events or status indicators shown in calendar grid 220 are retrieved from a calendar (e.g., a calendar stored at consumer portal 190) associated with the corresponding contact.

The user 145 can make selections on EPG screen 200 using, for example, a cursor. In the depicted example, a highlighted item 225 has been selected by user 145. In some embodiments, an informational window 250 can be provided to display further details and/or instructions to user 145 in connection with the selected item 225. Illustrative examples of information that can be shown in informational window 250 include presence information, conventional contact information (such as a phone number), and instructions on how to initiate a video call.

In an embodiment, the user 145 can initiate a video call, e.g., by pressing an “OK” button on an input device, or by selecting a menu choice (such as “Video Call”) from a menu of EPG 125. Client system 101 then initiates a video call to the contact selected from favorite list of contacts 215.

In some embodiments, a window or reserved area can be provided for a status video 260. In further illustrative embodiments, status video 260 can be shown in a pop-up window or in a background area of the EPG screen 200. When the user 145 selects a contact from favorite list of contacts 215 (e.g., by clicking on, or moving the cursor over, a displayed name in favorite list of contacts 215 or an event or a presence indicator in calendar grid 220), a status video 260 may be displayed. In some embodiments, the status video 260 may begin playing automatically; in other embodiments, a thumbnail or a still frame from status video 260 may be displayed, with further action required from the user 145 to initiate playing.

An exemplary status video 260 can be a short video recorded by the corresponding contact, using the contact's own smart camera device 110 or using, for example, a conventional video camera or video recording device. Illustrative examples of content of status video 260 include video of the contact announcing, “I am not available right now. Please call back at 6 PM,” or “I am at home tonight. Call me anytime,” or “I am skiing in Utah this week. Please remember to water my plants.” It will readily be appreciated that status video 260 can be an individualized expression, and may include any messages, scenery, persons, or other audio and/or video that the contact chooses to record, in addition to or instead of presence information or status information.

For a given user 145, the favorite list of contacts 215, as well as the status video 260 of each contact in the user's favorite list of contacts 215, can be stored or cached in persistent storage of the user's smart camera device 110, persistent storage of the user's STB 120 (e.g., a hard drive), or stored at consumer portal server 190. In an embodiment, client system 101 can periodically request updates, or can periodically receive published or pushed updates, of the status video 260 of each contact in the user's favorite list of contacts 215.

In an illustrative example, as contacts within the favorite list of contacts 215 change their recorded status videos 260, the smart camera device 110 of the user 145 is notified, and the smart camera device 110 receives updated status videos 260 (e.g., an updated status video 260 recorded by a contact within the favorite list of contacts 215 using the contact's own smart camera device 110). This technique can be implemented, for example, using SIP SUBSCRIBE, NOTIFY, and PUBLISH methods.

In many cases, the user 145 will appear on another user's favorite list of contents 215. The user 145 can create his own status video 260, for example, using smart camera device 110. In further embodiments, user 145 can use any conventional video camera or video recording device to create status video 260. In an embodiment, status video 260 can be manually or automatically uploaded to consumer portal server 190.

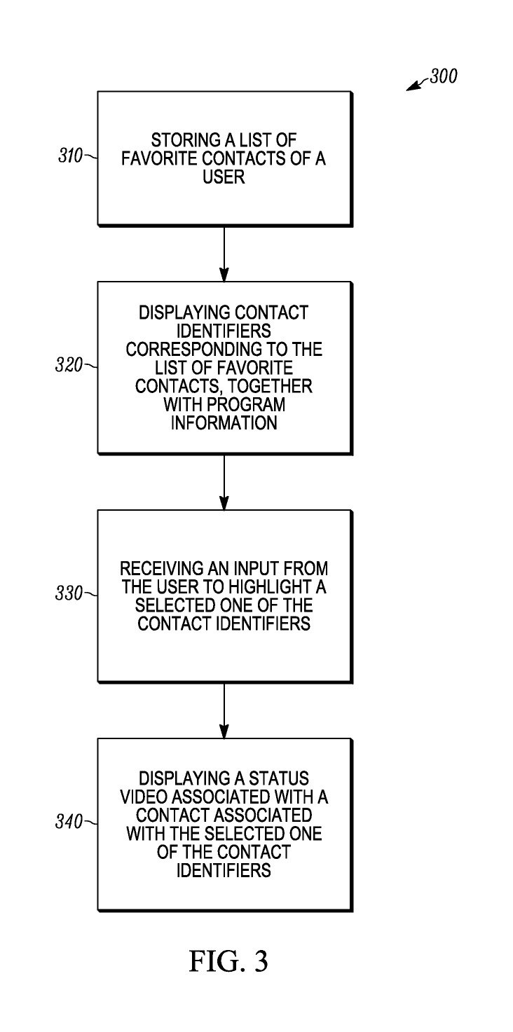

FIG. 3 is a flow diagram that illustrates a method 300 according to an embodiment of the present invention. In one embodiment, the method 300 includes a step 310 of storing a list of favorite contacts of a user.

In step 320, a user interface of electronic program guide (EPG) 125 displays a plurality of contact identifiers corresponding to the list of favorite contacts, together with program information. For example, EPG 125 causes the contact identifiers and the program information to be displayed together by STB 120 on display 140.

In step 330, an input is received (e.g., in STB 120) from the user 145 to highlight a selected one of the contact identifiers. For example, the user 145 may operate a mouse, trackpad, touchscreen, etc., to highlight the selected identifier, or may operate buttons of a remote control device.

In step 340, the EPG user interface displays (e.g., on display 140) a status video 260 associated with a contact associated with the selected one of the contact identifiers.

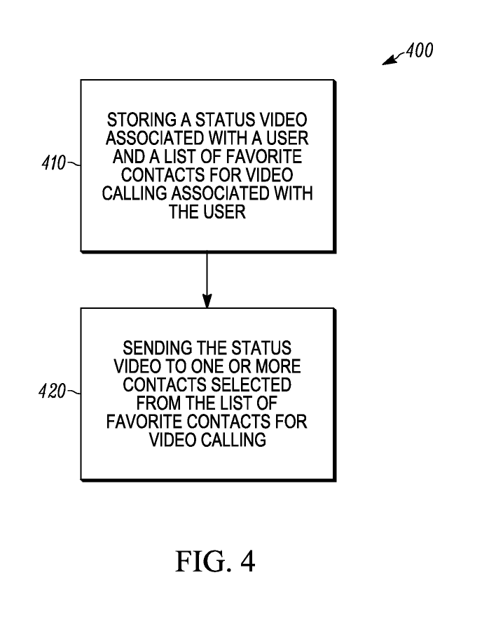

FIG. 4 is a flow diagram that illustrates a method 400 according to a further embodiment of the present invention. In one embodiment, the method 400 for video calling includes a step 410 of storing, in a consumer portal server 190, a status video 260 associated with a user 145, and a list of favorite contacts 215 associated with the user 145.

In step 420, the status video is sent to one or more contacts selected from the list of favorite contacts 215.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for presenting information associated with a contact for video calling, the method comprising:
storing a list of favorite contacts of a user;
in an electronic program guide (EPG) user interface, displaying a plurality of contact identifiers corresponding to the list of favorite contacts, together with program information;
receiving an input from the user to highlight a selected one of the contact identifiers;
in the EPG user interface, displaying a status video associated with a contact associated with the selected one of the contact identifiers.

2. The method of claim 1, further comprising:
in the EPG user interface, displaying presence information associated with the contact associated with the selected one of the contact identifiers.

3. The method of claim 2, further comprising:
receiving the presence information from a consumer portal server.

4. The method of claim 1, further comprising:
receiving the status video from a consumer portal server.

5. The method of claim 1, further comprising:
receiving the list of favorite contacts from a consumer portal server.

6. The method of claim 1, further comprising:
receiving a second input from the user to initiate a video call to the contact associated with the selected one of the contact identifiers;
sending a request to a call control server for initiating the video call.

7. A method for presenting information associated with a contact for video calling, the method comprising:
in a consumer portal server, storing a status video associated with a user and a list of favorite contacts for video calling associated with the user; and
sending the status video to one or more contacts selected from the list of favorite contacts for video calling.

8. The method of claim 7, further comprising:
in a smart camera device, recording the status video; and
sending the status video to the consumer portal server.

9. The method of claim 7, wherein the sending is responsive to an authenticated request received from the one or more contacts.

10. The method of claim 7, wherein the sending comprises pushing the status video to the one or more contacts, using a functionality selected from the group consisting of Really Simple Syndication (RSS), Session Initiation Protocol (SIP) notify, Hypertext Transfer Protocol (HTTP) server push, and Comet.

11. The method of claim 7, further comprising:
in the consumer portal server, storing presence information associated with the user; and
sending the presence information to one or more contacts selected from the list of favorite contacts for video calling.

12. A system for presenting information associated with a contact for video calling, comprising:
a set-top box (STB) configured to output video to a display,
the STB communicatively coupled to an access network for accessing a consumer portal server and a call control server;
the STB comprising a processor configured to execute an electronic program guide (EPG) application;
wherein a user interface of the EPG application is configured to display together on the display:
program schedule information,
a plurality of contact identifiers corresponding to a list of favorite contacts for video calling associated with a user of the set-top box, and
a status video associated with a selected contact of the list of favorite contacts.

13. The system of claim 12, further comprising a smart phone device configured to send a status video associated with a user of the set-top box to the consumer portal server.

14. The system of claim 12, wherein the status video associated with the selected contact is received from the consumer portal server.

15. The system of claim 12, wherein the consumer portal server stores a status video associated with a user of the set-top box.

16. The system of claim 12 wherein the list of favorite contacts is received from the consumer portal server.

17. A non-transitory computer readable medium comprising stored instructions which, when executed by a processor, implement a method for video calling, the instructions comprising:
instructions for retrieving a list of favorite contacts of a user;
instructions for displaying, in an electronic program guide (EPG) user interface, a plurality of contact identifiers corresponding to the list of favorite contacts, together with program information;
instructions for receiving an input from the user to highlight a selected one of the contact identifiers;
instructions for displaying, in the EPG user interface, a status video associated with a contact associated with the selected one of the contact identifiers.
